(19) United States
(12) Patent Application Publication
(10) Pub. No.: US 2009/0047843 A1
(43) Pub. Date: Feb. 19, 2009

(54) Spiral Contactor

(76) Inventors: Taiji Okamoto, Miyagi-ken (JP); Akira Watanabe, Miyagi-ken (JP)

Correspondence Address: BRINKS HOFER GILSON & LIONE, P.O. BOX 10395, CHICAGO, IL, 60610, US

(21) Appl. No.: 11/909,400

(22) PCT Filed: Mar. 17, 2006
(86) PCT No.: PCT/JP2006/305377

§ 371 Date: Sep. 21, 2007

(30) Foreign Application Priority Data
Mar. 23, 2005 (JP) 2005-083151

(51) Int. Cl. H01R 13/24

(52) U.S. Cl. 439/700

(57) ABSTRACT

[Object] To provide a spiral contactor that has a spiral-shaped elastic arm having a stable elastic function and less unevenness, and is easy to manufacture.

[Solving Means] An elastic arm 3 composed of an electrically conductive material such as copper or the like is formed in a spiral shape from a base end 4 substantially up to spiral end normal Oθ and the portion forward thereof is sharply bent so that a tip 5 is located substantially in the center. The elastic arm 3 can elastically deform in a long range and exert a stable elastic force. Additionally, this spiral contactor is easily manufactured by an etching process or the like, as a wide space is formed between elastic arm portions of a spiral shape.

### TECHNICAL FIELD

The present invention relates to a spiral contactor that has an electrically conductive elastic arm formed in a spiral shape and functions as an elastic contact point, more particularly to a spiral contactor, the elastic arm of which has an elastic function over its substantially entire length, also has good contactability with a facing electrical conductor, and is easy to manufacture.

### BACKGROUND ART

A spiral contactor composed of a micro-sized elastic arm having a spiral shape is described, for example, in the following Patent Document 1. The elastic arm described in the Patent Document 1 is formed through an etching process or the like and is configured in a flat spiral shape. When the elastic arm is pushed by a spherical connection terminal provided on a semiconductor device or the like, the arm is elastically deformed inwardly into a through hole of a substrate and is elastically pressed against the spherical connection terminal by the recoiling force of the arm, which makes them electrically connected.

Patent Document 1: Japanese Unexamined Patent Application Publication No. 2002-175859

### DISCLOSURE OF INVENTION

### Problems to be Solved by the Invention

The spiral shape of the spiral contactor described in the Patent Document 1 is such that the elastic arm is not located at the center of the external shape thereof and the tip portion of the elastic arm is disposed in the vicinity of the center. This spiral contactor is formed in a plane and when it is pushed by a spherical connection terminal, the tip portion of the elastic arm contacts to the spherical connection terminal so as to wind around the spherical surface. Accordingly, it is difficult to provide secure contact of the spiral contactor with other than the spherical connection terminal, for example, a flat electrode. Furthermore, although it is desirable that the contact between the spiral contactor and a facing electrode or the like is made so that the shortest part of the edge portion of the elastic arm rubs the surface of the electrode to remove an oxidation layer thereon, the spiral contactor of the type described in the Patent Document 1 contacts to the spherical connection terminal so as to wind around the surface thereof; therefore, such a spiral contactor is not optimal from a functional point of view on removing an oxidation layer or the like.

As explained later with reference to the comparable example shown in FIG. 5, it is considered that the elastic arm is configured to be spirally extended to a point near the center of the external shape of the spiral contactor, and the tip portion of the elastic arm is positioned near the center for making contact with a facing electrode. However, forming a spiral elastic arm of multiple winding in a narrow area makes the density of the elastic arm portion higher, which leads to difficulty in manufacturing such a spiral arm. Moreover, a portion having an elastic function is limited to a short distance from the base end, and a large portion of the tip side substantially functions as a rigid body. Consequently, it is limited to enhance the elastic contact force of the tip portion, and unevenness in elastic forces among the products tends to arise.

The present invention addresses the above problems with the object of providing a spiral contactor that has a good contactability to an electrode, includes an elastic arm having a sufficient elastic function, and is easy to manufacture.

### Means of Solution of the Problems

The first present invention provides a spiral contactor that has an electrically conductive elastic arm extending from its base end toward its tip, the elastic arm being formed in a spiral shape so as to have the tip located in the inner side of the spiral with respect to the base end when seen in a plan view; wherein the spiral contactor is characterized in that, if an arm center line bisecting a width dimension of the elastic arm at all points thereon is represented as φ, a graphical center of the tip of the elastic arm is represented as O, a first reference cross-line passing through the base end and the graphical center O is represented as X0, a second reference cross-line passing through the graphical center O and perpendicular to the first reference cross-line X0 is represented as Y0, a first external tangent line perpendicular to the second reference cross-line Y0 and tangential to the outermost rim of the elastic arm on the side where the elastic arm extends from the base end is represented as X1, and a second external tangent line perpendicular to the second reference cross-line Y0 and tangential to the outermost rim of the elastic arm in the region located at the opposite side of the first external tangent line X1 with respect to the first reference cross-line X0 is represented as X2, two turns of the elastic arm are disposed between the first reference cross-line X0 and the first external tangent line X1, and one turn of the elastic arm is disposed between the first reference cross-line X0 and the second external tangent line X2.

The spiral contactor can be configured so that the elastic arm has the spiral length of 1.25 winding turns or less; after being wound one to 1.25 turns, for example, the elastic arm can be sharply bent so as to have its tip portion located substantially at the center of the external shape. The tip portion can be thereby contacted to a facing electrode or the like with certainty. Additionally, the elastic force becomes stable and uneven elastic forces tend not to arise, as the range of an elastic arm portion substantially having an elastic function can be prolonged. Furthermore, the number of winding turns of the elastic arm can be minimized, by which the manufacturing becomes easier.

In the present invention, it is also desirable that, if a first central tangent line perpendicular to the first reference cross-line X0 and tangential to the arm center line φ at the base end is represented as Y1, and a second central tangent line perpendicular to the first reference cross-line X0 and tangential to the outermost arm center line φ in the region located at the opposite side of the first central tangent line Y1 with respect to the second reference cross-line Y0 is represented as Y2, two turns of the elastic arm are disposed between the second reference cross-line Y0 and the first central tangent line Y1, and one turn of the elastic arm is disposed substantially between the second reference cross-line Y0 and the second central tangent line Y2.

Moreover, it is desirable that the graphical center O of the tip is positioned substantially in the middle between the first external tangent line X1 and the second external tangent line X2, or in addition to being positioned substantially in the middle between the first external tangent line X1 and the second external tangent line X2, the graphical center O is positioned substantially in the middle between first central tangent line Y1 and the second central tangent line Y2.

A second present invention provides a spiral contactor that has an electrically conductive elastic arm extending from its base end toward its tip, the elastic arm being formed in a spiral shape having the tip located in the inner side of the spiral with respect to the base end when seen in a plan view; wherein the spiral contactor is characterized in that, if an arm center line bisecting a width dimension of the elastic arm at all points thereon is represented as φ, a graphical center of the tip of the elastic arm is represented as O, a first reference cross-line passing through the base end and the graphical center O is represented as X0, a second reference cross-line passing through the graphical center O and perpendicular to the first reference cross-line X0 is represented as Y0, a first external tangent line perpendicular to the second reference cross-line Y0 and tangential to the outermost rim of the elastic arm on the side where the elastic arm extends from the base end is represented as X1, a second external tangent line perpendicular to the second reference cross-line Y0 and tangential to the outermost rim of the elastic arm in the region located at the opposite side of the first external tangent line X1 with respect to the first reference cross-line X0 is represented as X2, a first central tangent line perpendicular to the first reference cross-line X0 and tangential to the arm center line φ at the base end side is represented as Y1, and a second central tangent line perpendicular to the first reference cross-line X0 and tangential to the outermost arm center line φ in the region located at the opposite side of the first central tangent line Y1 with respect to the second reference cross-line Y0 is represented as Y2, the graphical center O of the tip is positioned substantially in the middle between the first external tangent line X1 and the second external tangent line X2, and is also positioned substantially in the middle between first central tangent line Y1 and the second central tangent line Y2; the arm center line φ extending from the base end has its center of curvature at the graphical center O and the radius of curvature Rθ becomes gradually smaller with distance from the base end toward the tip; and in a specified range from the tip portion toward the base end, the center of curvature O1 of the arm center line φ is positioned apart from the graphical center O.

At that time, it is desirable that the radius r of the arm center line φ from the center of curvature O1 is smaller than the radius Rφ of the arm center line φ from the graphical center O.

In the present invention, it is preferable that a section modulus Z of the elastic arm decreases gradually from the base end to the tip or from the base end to the vicinity of the tip, and a rate of decrease of the section modulus Z varies substantially linearly.

The spiral contactor according to the present invention can be configured, if a total length of the arm center line φ from the graphical center O to the base end is represented as L0, a variable position on the arm center line φ starting from the graphical center O is represented as x, the section modulus of the elastic arm at the base end is represented as Z0, and the section modulus at the variable position x is represented as Zx, so that (Zx/Z0)=(x/L0) holds substantially over the entire length of the elastic arm.

If configured as described above, when a load is applied onto the tip of the elastic arm, bending stresses put on the surface of the elastic arm can be equalized substantially over the entire length, and the elastic arm can be deformed evenly over its entire length. Therefore, fatigue of the elastic arm when a load is applied can be reduced, and each of the products is provided with a uniform elastic force.

Alternatively, if a total length of the arm center line φ from the graphical center O to the base end is represented as L0, a variable position on the arm center line φ starting from the graphical center O is represented as x, the section modulus of the elastic arm at the base end is represented as Z0, and the section modulus at the variable position x is represented as Zx, the spiral contactor can be configured so that (Zx/Z0)=(x/L0) holds substantially over the entire length of the elastic arm except for the portion having the radius r.

In addition to the above, the spiral contactor according to the present invention can be configured in a manner such that the tip is positioned in a vertical direction apart from the plane passing through the base end when no load is applied.

The three-dimensional configuration described above enables the tip portion to be contacted also to a flat electrode with certainty, and is helpful in removing a surface layer of the electrode with an edge of the tip portion when the elastic arm is deformed by a load applied thereon.

The present invention is effective in the case where the distance between the first external tangent line X1 and the second external tangent line X2 is 0.5 mm or less.

### EFFECT OF THE INVENTION

The present invention offers advantages such that a spiral contactor can be configured with a minimum number of winding turns, and a tip portion of its elastic arm can be easily contacted with a facing electrode or the like. Additionally, a large portion having an elastic function in the elastic arm can be secured, a stable elastic force is obtained as a whole, and unevenness in elastic forces among the products tend not to arise. Furthermore, since the spiral shape is configured with a minimum number of winding turns, manufacturing becomes easy.

### BRIEF DESCRIPTION OF THE DRAWINGS

FIG. 1 is a magnified plan view of a spiral contactor according to an embodiment of the present invention.

FIG. 2 is a side view of the spiral contactor according to an embodiment.

FIG. 3 is an explanatory drawing of an elastic function of an elastic arm.

FIGS. 4(A) and 4(B) are explanatory drawings showing examples of the elastic arm.

FIG. 5 is a magnified plan view showing an exemplary comparable spiral contactor.

### REFERENCE NUMERALS

1 spiral contactor
2 mount portion
3 elastic arm
4 base end
5 tip
6 tip portion

### BEST MODE FOR CARRYING OUT THE INVENTION

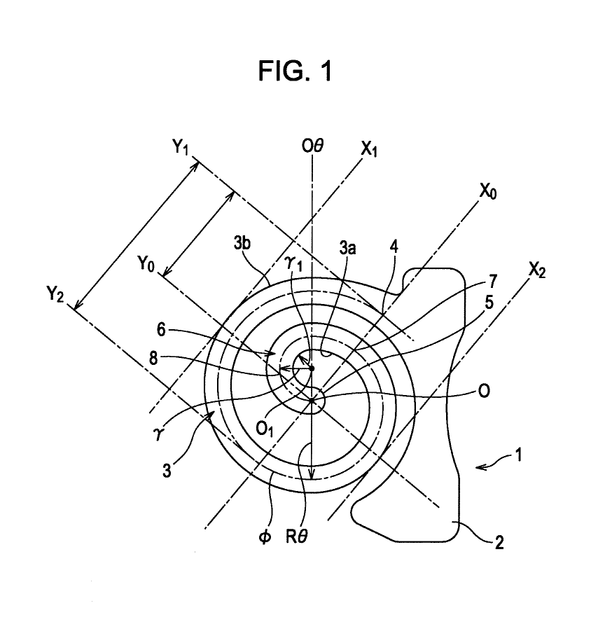

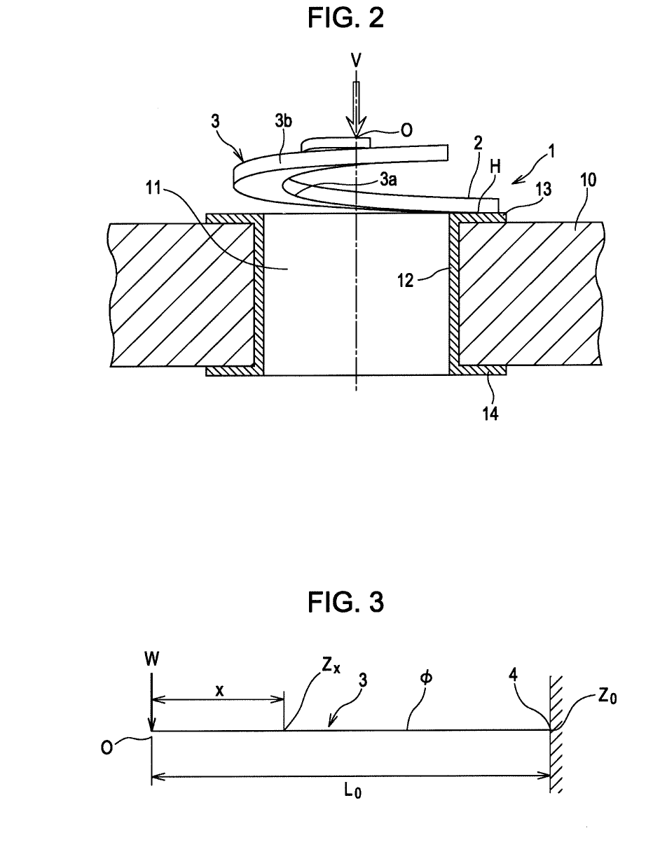

FIG. 1 is a magnified plan view of a spiral contactor 1 according to an embodiment of the present invention and FIG. 2 is a side view of the spiral contactor 1.

The spiral contactor 1 is formed by an etching method or a plating method. In the etching method, a shape shown in FIG. 1 is formed by etching a thin plate-like copper film, and then a reinforcing material such as nickel or nickel-phosphorus is plated on the surface thereof. The spiral contactor 1 can also be formed of a laminated material composed of copper and nickel or copper and nickel-phosphorus. In this configuration, nickel or nickel-phosphorus mainly exerts an elastic function, and copper functions to reduce specific resistance.

Alternatively, the spiral contactor 1 can be formed by plating a copper layer, or by forming a laminated film of copper and nickel, or copper and nickel-phosphorus through a continuous plating process.

As shown in FIG. 1, a flat mount portion 2 having a specified film thickness and an elastic arm 3 extending from the mount portion 2 of the spiral contactor 1 are formed in one piece. The elastic arm 3 has its base end 4 at a boundary portion adjacent to the mount portion 2, and has its tip 5 positioned substantially at the center of the spiral pattern. In FIG. 1, an arm center line of the elastic arm 3 is shown with φ. The arm center line φ is a continuous line that bisects the width dimension of the elastic arm at any point thereon; this arm center line φ is also of a spiral shape.

In FIG. 1, a graphical center of the tip 5 of the elastic arm 3 is shown with O. The graphical center O in this specification means that the distances from the outer edge of the elastic arm 3 are equal to each other at the tip 5, or in other words, the graphical center O means to be a barycenter of the plane shape in a certain length of the tip 5 of the elastic arm 3.

FIG. 2 shows the spiral contactor 1 and a substrate 10 supporting it. The substrate 10 has a through hole 11, which is provided with a wall face conductor 12 on its inner wall face. On the surface of the substrate 10, a surface electrode portion 13 electrically connected to the wall face conductor 12 is formed, and on the on the rear surface of the substrate 10, a rear-surface electrode portion 14 electrically connected to the wall face conductor 12 is formed.

The mount portion 2 is rigidly bonded to the surface electrode portion 13 by means of an electrically conductive adhesive over substantially its entire area. In FIG. 2, the undersurface of the mount portion 2 (the boundary surface between the mount portion 2 and the surface electrode portion 13) is represented defined as a reference plane H, and the vertical line to the reference plane, passing through the graphical center O, is represented by V. The vertical line V is positioned substantially at the center of the through hole 11. The elastic arm 3 has a three-dimensional shape; wherein the tip 5 is positioned apart from the reference plane H in a vertical direction. This three-dimensional shape can be finished in a manner such that, after being formed, the elastic arm 3 is heated to release internal stresses for a designated time in the state that the tip 5 is pushed upward. It is also possible to three-dimensionally shape the elastic arm 3 beforehand through a plating process or the like.

On the surface of the substrate 10, the plurality of spiral contactors 1 are disposed in a matrix-like arrangement. The arrangement pitch between adjacent spiral contactors 1 is, for example, in a range of 30 to 500 μm, and the maximum outline diameter of the outer rim of the elastic arm 3 is 0.5 mm or less, i.e., for example, an order of 20 μm to 400 μm.

As described above, the mount portion 2 is fixed in a state of being flat, and the elastic arm 3 is in a free state from the base end 4. Let an imaginary line passing through the base end 4 and the graphical center O be a first reference cross-line X0, and let another imaginary line passing through the graphical center O and perpendicular to the first reference cross-line X0 be a second reference cross-line Y0. When seen in a plan view of FIG. 1, the elastic arm 3 has a form of a spiral path wound from the base end 4 so that the radius of curvature Rφ of the arm center line φ becomes smaller with distance from the base end 4 toward the tip 5. The spiral path is wound from the base end 4 to a spiral end normal Oθ by approximately one to 1.25 turns (360 to 450 degree), more preferably by 1.1 to 1.2 turns (396 to 432 degree). In the embodiment shown in FIG. 1, the elastic arm 3 is wound from the base end 4 to a spiral end normal Oθ by approximately 400 degree.

In the range from the base end 4 to the spiral end normal Oθ, the center of curvature of the arm center line φ is positioned in the graphical center O or near the center, and the radius of curvature Rφ of the arm center line φ becomes gradually shorter with distance from the base end 4 toward the spiral end normal Oθ.

In the tip part 6 extending from the spiral end normal Oθ to the graphical center O of the tip, the arm center line φ is sharply bent and the graphical center O reaches substantially the spiral center. The radius of curvature r of the arm center line φ in the tip part 6 is extremely smaller than the radius of curvature Rφ of the arm center line φ from the base end 4 up to the spiral end normal Oθ; the ratio of the radius r to the radius of curvature Rφ at the intersection point 7 of the first reference cross-line X0 and the inner arm center line φ is ⅔ or less, more preferably ½ or less. Moreover, the center of curvature O1 of the radius r is located at a point apart from the graphical center O. The center of curvature O1 is positioned substantially on the spiral end normal Oθ. When an inner rim 3a denotes the spiral center side rim of the elastic arm 3 and an outer rim 3b denotes the other side rim, the elastic arm 3 is configured so that the inner rim 3a becomes to be an arc having a substantially constant radius r1 with respect to the center of curvature O1 in the range between from the spiral end normal Oθ to the graphical center O.

As the result that the spiral shape is configured as described above, the pattern shape of the elastic arm 3 becomes as follows.

An imaginary line passing through the intersection point of the second reference cross-line Y0 and the outer rim 3b positioned in the outermost side of the elastic arm 3, being tangent to the outer rim 3b thereat, and perpendicular to the second reference cross-line Y0 on the side where the elastic arm 3 extends from the base end 4 with respect to the first reference cross-line X0 is represented as a first external tangent line X1. Another imaginary line passing through the intersection point of the second reference cross-line Y0 and the outer rim 3b positioned in the outermost side of the elastic arm 3, being tangent to the outer rim 3b thereat, and perpendicular to the second reference cross-line Y0 in the region located at the opposite side of the first external tangent line X1 with respect to the first reference cross-line X0 is represented as a second external tangent line X2. As shown in FIG. 1, there are disposed two turns of the elastic arm 3 between the first reference cross-line X0 and the first external tangent line X1; on the other hand there is disposed one turn of the elastic arm 3 between the first reference cross-line X0 and the second external tangent line X2.

Next, a first central tangent line passing through the intersection point of the first reference cross-line X0 and the arm center line φ at the base end 4, being tangent to the arm center line φ thereat, and perpendicular to the first reference cross-line X0 is represented as Y1; a second central tangent line passing through the intersection point of the first reference cross-line X0 and the outermost arm center line φ, being tangent to the arm center line φ thereat, and perpendicular to the first reference cross-line X0 in the region located at the opposite side of the first central tangent line Y1 with respect to the second reference cross-line Y0 is represented as Y2. As shown in FIG. 1, there are disposed two turns of the elastic arm 3 between the second reference cross-line Y0 and the first central tangent line Y1; on the other hand there is disposed substantially one turn of the elastic arm 3 (a portion of the elastic arm 3 excluding the tip part 6) between the second reference cross-line Y0 and the second central tangent line Y2.

In this spiral contactor 1, the portion of the elastic arm 3 substantially having an elastic function is in a range from the base end 4 up to the spiral end normal Oθ, more preferably up to the vicinity of the intersection point 8 of the second reference cross-line Y0 and the arm center line φ. If the total length (straightened length) of the arm center line φ from the base end 4 up to the graphical center O is represented as L0, the range having the elastic function is 70% or more, or 80% or more, and even enabled to be 90% or more.

In order to materialize that the elastic arm 3 has an elastic function from the base end 4 up to the spiral end normal Oθ, more preferably up to the graphical center O, and is enabled to be elastically deformed when a load W is applied onto the graphical center O, the sectional shape of the elastic arm 3 is configured as follows.

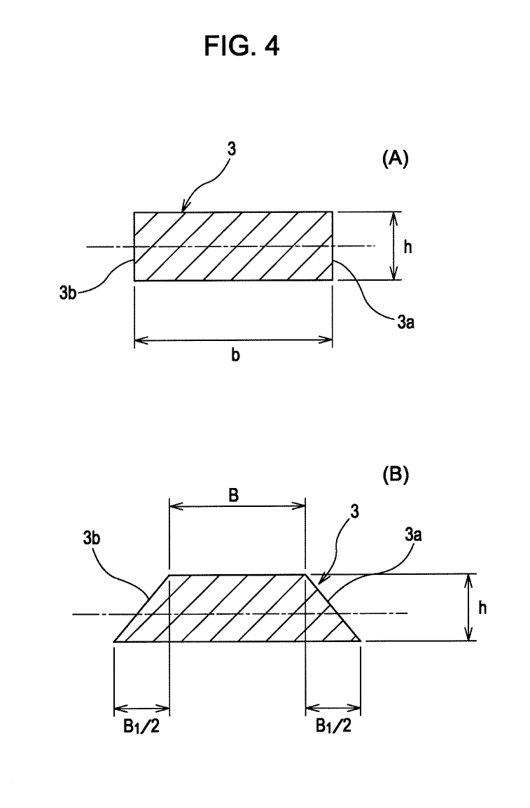

The total length of the elastic arm 3 extending from the base end 4 up to the spiral end normal Oθ and also the total length extending from the base end 4 up to the vicinity of the graphical center O are short, and yet the radius of curvature Rφ having its center on the graphical center O is larger than the width dimension of the elastic arm 3. As shown in FIGS. 4(A) and 4(B), the elastic arm 3 has such a cross-sectional shape that its width dimension is larger than its thickness dimension. Furthermore, the amount of displacement of the graphical center O in the direction of the vertical line V is smaller than the outer dimension of the spiral (the distance between the first external tangent line X1 and the second external tangent line X2). Consequently, when a concentrated load W is applied downwardly from above onto the graphical center O as shown in FIG. 2, the elastic function of the elastic arm 3 can be dealt with in an approximate manner such that a twisting deformation can be neglected and a bending deformation arises along the direction of the arm center line φ.

That is, it is possible to approximate the elastic function of the elastic arm 3 with a cantilever that has a straightened arm center line φ and is fixed at the base end as shown in FIG. 3. As shown in FIG. 3, the coordinate of a variable position along the arm center line φ and also its variable distance from the graphical center O toward the base end 4 is represented by x, the section modulus of the elastic arm 3 at the position x is represented by Zx, and the section modulus of the elastic arm 3 at the base end 4 is represented by Z0. The stress arising on both front surface and back surface of the elastic arm 3 at the position x becomes (W·x/Zx), as the applied moment is W·x. The stress arising on both front surface and back surface of the elastic arm 3 at the base end 4 becomes (W·L0/Z0), as the applied moment is W·L0. If the surface stress at the variable position x is equal to that at the base end 4, bending occurs in the range from the base end 4 up to the graphical center O of the elastic arm 3 when the concentrated load W is applied onto the graphical center O. The condition for that is (W·x/Zx)=(W·L0/Z0), i.e., (Zx/Z0)=(x/L0). Incidentally, it is preferable in the present invention that the left side of the above equation is exactly equal to the right side, but it is acceptable that the left side and the right side are approximately equal, and as the result, the elastic arm 3 is deformed over the entire range from the base end substantially up to the spiral end normal Oθ when the load is applied.

Furthermore, even in the case when the above equation does not hold, if the elastic arm 3 has such a section modulus Z as to become smaller gradually from the base end 4 to the tip, or from the base end 4 substantially to the spiral end normal Oθ, and the rate of decrease of the section modulus Z varies substantially linearly, the elastic arm 3 can be configured to be deformed over the entire range from the base end 4 substantially to the spiral end normal Oθ when the load is applied.

By being formed so as to have its section modulus Z satisfying or substantially satisfying the equation, the elastic arm 3 is enabled to be deformed over the substantially entire length. As described above, however, the tip part 6 near the graphical center O tends to function as a rigid body since the elastic arm 3 is sharply bent there so as to have the radiuses r and r1. Even so, the elastic arm 3 is enabled to be deformed at least over the range from the base end 4 up to the spiral end normal Oθ.

What is described above can be applied to the case in which an elastic arm 3 having a flat shape is formed into a three-dimensional shape shown in FIG. 2. To form the three-dimensional shape shown in FIG. 2, after the elastic arm 3 is formed in a flat shape by an etching method or the like, the graphical center O is thrust upward from below along the vertical line V and is heated for a designated time under the condition to release internal stress. In this process, the elastic arm 3 can be deformed at least over the range from the base end 4 to the spiral end normal Oθ when an load is applied from below to the graphical center O, so the substantially entire length of the elastic arm 3 is three-dimensionally deformed after stress release as shown in FIG. 2, and as the result, the elastic arm 3 can have a three-dimensional shape with the graphical center O and the vicinity thereof being situated at the highest position with respect to the reference plane H.

Next, examples of a cross-sectional shape of the elastic arm 3 are shown in FIGS. 4(A) and 4(B). A cross-sectional shape of the elastic arm 3 is formed into a rectangle shown in FIG. 4(A), or in the case when the spiral contactor 1 is formed by an etching method, the cross-sectional shape of the elastic arm 3 is formed substantially into a trapezoid as shown in FIG. 4(B) since an inclined face is formed at both the inner rim 3a and the outer rim 3b.

When the cross-section of the elastic arm 3 is a rectangle as shown in FIG. 4(A), its width dimension represented as b is larger than its thickness dimension represented by h: (h<b), and the section modulus Z of the elastic arm is (b·h²/6). If b represents a variable that varies depending on a distance x, and b0 represents a constant width dimension of the elastic arm at the base end, (Zx/Z0) of the above equation (Zx/Z0)=(x/L0) becomes (b·h²/6)/(b0·h²/6). Here, if the thickness dimension h of the elastic arm 3 is assumed to be constant over the entire length thereof, (Zx/Z0)=(b/b0) is obtained. Accordingly, if the width dimension b is varied depending on a distance x so that (b/b0)=(x/L0) is satisfied, the elastic arm 3 can be deformed at least in the range from the base end 4 up to the spiral end normal Oθ. If the thickness h is constant, it possible to satisfy (b/b0)=(x/L0) by reducing the width dimension b linearly from the base end 4 toward the graphical center O or toward the spiral end normal Oθ. That is, it is achieved by reducing the cross-sectional area of the elastic arm 3 linearly from the base end 4 toward the graphical center O or toward the spiral end normal Oθ.

When the cross-section of the elastic arm 3 is a trapezoid as shown in FIG. 4(B), if its upper width dimension is represented as B, its lower width dimension is represented as (B+B1), and its thickness dimension represented as h, (h<B) holds and the section modulus of the elastic arm 3 is expressed as (6B²+6B·B1+B1²)·h²/12(3B+B1).

The thickness h of the elastic arm 3 is constant, and B1 is also a constant since the inclination width (1/B1) of each of the inner rim 3a and the outer rim 3b is substantially constant over the entire length of the elastic arm 3 when formed by an etching method, and then only B is a variable that varies depending on the variable distance x. If B0 represents an upper width dimension of the elastic arm at the base end 4, (Zx/Z0) is expressed as 6B²+6B·B1+B1²)(3B0+B1)}/{(6B0²+6B0·B1+B1²)(3B+B1)}. If the upper width dimension B is varied depending on a distance x so that the above expression becomes equal to (x/L0), the elastic arm 3 can be deformed at least in the range from the base end 4 up to the spiral end normal Oθ.

It is noted that when B1 is small in comparison to the upper width dimension B, the cross-section of the elastic arm 3 can be considered to be substantially equal to a rectangle, and in this case, the same conditions as described based on the case shown in FIG. 4(A) can be applied.

Consequently, in a three-dimensional shape shown in FIG. 2, the graphical center O can be located at the highest position with respect to the reference plane H. This spiral contactor 1 can be, of course, pushed to a spherical electrode or a cone-shaped electrode, and even when being pushed to a flat electrode, its elastic arm 3 elastically deforms and assures reliable electrical continuity. In either case, the portion having the graphical center O contacts first to the electrode, and as the electrode is further pushed, an edge of the tip 5 of the elastic arm 3 rubs the surface of the electrode and removes an oxidation layer and the like thereon, which brings about reliable electrical continuity between the elastic arm 3 and the electrode.

In addition, since the elastic arm 3 can exert an elastic force in a long range from the base end and also can elastically deforms, elastic forces become stable and unevenness in elastic forces tends not to arise. Moreover, since stress is distributed over substantially entire length of the elastic arm 3, fatigue due to repeated usage and the like tends not to remain. Additionally, as shown in FIG. 1, since the winding angle of the spiral of the elastic arm 3 is small, there are formed wide spaces between the first reference cross-line X0 and the first external tangent line X2, and between the second reference cross-line X0 and the second central tangent line Y2. Therefore, a wide region where a conductive material is removed during an etching process is provided, which facilitates its manufacturing.

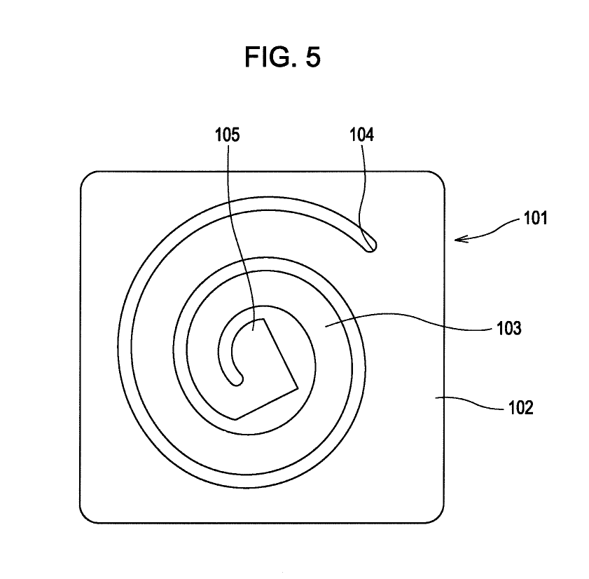

In FIG. 5, a comparable example is shown for comparison with the embodiment shown in FIG. 1. The spiral contactor 101 of the comparable example has a mount portion formed in its peripheral area and a spiral-shaped elastic arm 103 formed in the middle portion. The spiral-shaped elastic arm 103 has its tip 105 positioned substantially in the center. The elastic arm 103, however, has a shape wound from the base end 104 to the tip 105 by 1.5 turns (540 degree) or more. Accordingly, the space between ribs of the elastic arm is narrow, which make its manufacturing process such as an etching and the like difficult.

Furthermore, the path length from the base end 104 up to the tip 105 is long, and the rate of variation in the width dimension of the elastic arm 3 extending from the base end 104 toward the tip 105 is small; whereby, although a portion of the elastic arm wound around one turn from the base end 104 can elastically deform when a load is applied onto the tip 105 in a vertical direction, the further forward portion substantially functions as a rigid body and tends not to elastically deform. For this reason, the elastic force of the elastic arm 103 is not stable and tends to become uneven. Additionally, when the elastic arm 103 is formed into a three-dimensional shape, the base end 104 and its vicinity might be lifted together and the tip 105 is not always located at a highest position.

The spiral contactor 1 according to the embodiment shown in FIGS. 1 and 2 should be a one that almost resolves problems with the comparable example shown in FIG. 5.

It is noted that although the spiral contactor 1 according to the above embodiment is formed into a three-dimensional shape as shown in FIG. 2, the spiral contactor 1 of the present invention can be formed so that its elastic arm 3 has a spiral shape in a plane.

1. A spiral contactor having an electrically conductive elastic arm extending from its base end toward its tip, the elastic arm being formed in a spiral shape having the tip located in the inner side of the spiral with respect to the base end when seen in a plan view,
wherein, if an arm center line bisecting a width dimension of the elastic arm at all points thereon is represented as φ, a graphical center of the tip of the elastic arm is represented as O, a first reference cross-line passing through the base end and the graphical center O is represented as X0, a second reference cross-line passing through the graphical center O and perpendicular to the first reference cross-line X0 is represented as Y0, a first external tangent line perpendicular to the second reference cross-line Y0 and tangential to the outermost rim of the elastic arm on the side where the elastic arm extends from the base end is represented as X1, and a second external tangent line perpendicular to the second reference cross-line Y0 and tangential to the outermost rim of the elastic arm in the region located at the opposite side of the first external tangent line X1 with respect to the first reference cross-line X0 is represented as X2,
two turns of the elastic arm are disposed between the first reference cross-line X0 and the first external tangent line X1, and one turn of the elastic arm is disposed between the first reference cross-line X0 and the second external tangent line X2.

2. The spiral contactor according to claim 2,
wherein, if a first central tangent line perpendicular to the first reference cross-line X0 and tangential to the arm center line φ at the base end is represented as Y1, and a second central tangent line perpendicular to the first reference cross-line X0 and tangential to the outermost arm center line φ in the region located at the opposite side of the first central tangent line Y1 with respect to the second reference cross-line Y0 is represented as Y2,
two turns of the elastic arm are disposed between the second reference cross-line Y0 and the first central tangent line Y1, and one turn of the elastic arm is disposed substantially between the second reference cross-line Y0 and the second central tangent line Y2.

3. The spiral contactor according to claim 1 or 2,
wherein the graphical center O of the tip is positioned substantially in the middle between the first external tangent line X1 and the second external tangent line X2.

4. The spiral contactor according to claim 2,
wherein the graphical center O of the tip is positioned substantially in the middle between the first external tangent line X1 and the second external tangent line X2, and is also positioned substantially in the middle between first central tangent line Y1 and the second central tangent line Y2.

5. A spiral contactor having an electrically conductive elastic arm extending from its base end toward its tip, the elastic arm being formed in a spiral shape having the tip located in the inner side of the spiral with respect to the base end when seen in a plan view,
wherein, if an arm center line bisecting a width dimension of the elastic arm at all points thereon is represented as φ, a graphical center of the tip of the elastic arm is represented as O, a first reference cross-line passing through the base end and the graphical center O is represented as X0, a second reference cross-line passing through the graphical center O and perpendicular to the first reference cross-line X0 is represented as Y0, a first external tangent line perpendicular to the second reference cross-line Y0 and tangential to the outermost rim of the elastic arm on the side where the elastic arm extends from the base end is represented as X1, a second external tangent line perpendicular to the second reference cross-line Y0 and tangential to the outermost rim of the elastic arm in the region located at the opposite side of the first external tangent line X1 with respect to the first reference cross-line X0 is represented as X2, a first central tangent line perpendicular to the first reference cross-line X0 and tangential to the arm center line φ at the base end is represented as Y1, and a second central tangent line perpendicular to the first reference cross-line X0 and tangential to the outermost arm center line φ in the region located at the opposite side of the first central tangent line Y1 with respect to the second reference cross-line Y0 is represented as Y2,
the graphical center O of the tip is positioned substantially in the middle between the first external tangent line X1 and the second external tangent line X2, and is also positioned substantially in the middle between first central tangent line Y1 and the second central tangent line Y2;
the arm center line φ extending from the base end has its center of curvature at the graphical center O and the radius of curvature Rφ becomes gradually smaller with distance from the base end toward the tip; and
in a specified range from the tip portion toward the base end, the center of curvature O1 of the arm center line φ is positioned apart from the graphical center O.

6. The spiral contactor according to claim 5,
wherein the radius r of the arm center line φ from the center of curvature O1 is smaller than the radius Rφ of the arm center line φ from the graphical center O.

7. The spiral contactor according to any one of claims 1 to 6,
wherein a section modulus Z of the elastic arm decreases gradually from the base end to the tip or from the base end to the vicinity of the tip, and the rate of decrease of the section modulus Z varies substantially linearly.

8. The spiral contactor according to any one of claims 1 to 5,
wherein, if a total length of the arm center line φ from the graphical center O to the base end is represented as L0, a variable position on the arm center line φ starting from the graphical center O is represented as x, the section modulus of the elastic arm at the base end is represented as Z0, and the section modulus at the variable position x is represented as Zx,
(Zx/Z0)=(x/L0) holds substantially over the entire length of the elastic arm.

9. The spiral contactor according to claim 6,
wherein, if a total length of the arm center line φ from the graphical center O to the base end is represented as L0, a variable position on the arm center line φ starting from the graphical center O is represented as x, the section modulus of the elastic arm at the base end is represented as Z0, and the section modulus at the variable position x is represented as Zx,
(Zx/Z0)=(x/L0) holds substantially over the entire length of the elastic arm except for the portion having the radius r.

10. The spiral contactor according to any one of claims 1 to 9,
wherein the tip is positioned in a vertical direction apart from the plane passing through the base end when no load is applied.

11. The spiral contactor according to any one of claims 1 to 10,
wherein the distance between the first external tangent line X1 and the second external tangent line X2 is 0.5 mm or less.
